(19) United States
(12) Patent Application Publication
(10) Pub. No.: US 2005/0071110 A1
(43) Pub. Date: Mar. 31, 2005

(54) Method for identifying objects to be used in an automatic clinical analyzer

(76) Inventor: Randall R. Davis, Bear, DE (US)

Correspondence Address: DADE BEHRING INC.;LEGAL DEPARTMENT, 1717 DEERFIELD ROAD, DEERFIELD, IL, 60015, US

(21) Appl. No.: 10/670,882

(22) Filed: Sep. 25, 2003

(51) Int. Cl. G01M 19/00

(52) U.S. Cl. 702/123

(57) ABSTRACT

Automatically entering data into a clinical analyzer's operating control system, the data associated with an object to be placed into the clinical analyzer, by providing special symbols as an additional identifier in indicia affixed to the object.

### FIELD OF THE INVENTION

The present invention relates to a method and apparatus for automatically processing a patient's biological fluids such as urine, blood serum, plasma, cerebrospinal fluid and the like. In particular, the present invention provides a method for identifying and tracking objects such as consumables or components within an automatic clinical analyzer.

### BACKGROUND OF THE INVENTION

Various types of tests related to patient diagnosis and therapy can be performed by analysis of a sample of a patient's infection, bodily fluid or abscess for an analyte of interest. Patient samples are typically placed in closed sample tubes, the tubes transported to a clinical laboratory, placed into racks on an automated clinical analyzer and sample is extracted from the tubes. Subsequently, samples are combined in reaction vessels with various reagents extracted from reagent containers; the mixture is possibly incubated before being analyzed to aid in treatment of the patient. Interrogating measurements, turbidimetric or fluorometric or the like, are made to ascertain end-point or reaction rate values from which the amount of analyte in the sample may be determined, using well-known calibration techniques.

Automated clinical analyzers improve operating efficiency by providing results more rapidly while minimizing operator or technician error. Due to increasing demands on clinical laboratories regarding assay throughput, the accuracy and efficiency of providing consumable reagents, quality control and calibration solutions, and test devices or components within an analyzer continually needs to be increased. Hereinafter, reagents, quality control, and calibration solutions may be referred to as analytical solutions. A limiting factor in commercially available analyzers is the necessity for an operator to manually enter information concerning the identity and other information concerning analytical solutions, and test devices or components into an analyzer's control system.

Typically, items to be identified like containers for analytical solutions, carriers for analytical solution containers, patient sample tubes, sample tube racks, test devices, replaceable analyzer components and the like, are identified by conventional barcode labels affixed thereto. In some instances, however, a conventional barcode label may be too large to fit onto the item to be identified or the bar code label may be limited in size so that the amount of information coded thereon is limited. Alternately, an operator may be required to manually enter information concerning the item to be identified into a specific data entry point in the analyzer's operating control system, creating both an unnecessary use of time as well as increasing the possibility of data entry errors. All of these data entry limitations adversely affect the overall assay throughput of clinical analyzers.

### SUMMARY OF THE INVENTION

The present invention provides an improved method to automatically enter identifying data into a clinical analyzer's operating control system by providing special symbols as an additional identifier in order to enhance the identifying indicia on an identified item to be placed into an analyzer. Additionally, the present invention applies similarly enhanced high-information density, 2-dimensional matrix indicia labels to selected objects to be placed within with such an analyzer. The addition of two special characters forming a leading symbol at the beginning of the identifying indicia on objects to be placed within the analyzer enables the operating system to automatically direct the information obtained from the indicia to the appropriate location within the operating system without requiring operator intervention. Advantages in operational time and error reduction are thusly achieved.

### BRIEF DESCRIPTION OF THE DRAWINGS

The invention will be more fully understood from the following detailed description thereof taken in connection with the accompanying drawings which form a part of this application and in which:

FIG. 1 is a schematic plan view of an automated analyzer in which the present invention may be employed to advantage;

FIG. 2A is an enlarged schematic plan view of a portion of the analyzer of FIG. 1;

FIG. 2B is an analyzing unit useful in the analyzer of FIG. 1;

FIG. 2C is an integrated measuring sensor useful in the analyzing unit of FIG. 2B;

FIG. 3A is a perspective view of a sample tube and sample tube rack useful in performing the present invention;

FIG. 3B is a perspective view of a reagent container useful in the analyzer of FIG. 1 and useful in performing the present invention;

FIG. 4A is a perspective view of a vial container carrier useful in the analyzer of FIG. 1 and useful in performing the present invention;

FIG. 4B is an elevation view of the vial container carrier of FIG. 4A having a number of calibration solution vial containers therein;

FIG. 4C is an illustration of a display screen associated with the operation of the analyzer of FIG. 1;

FIG. 5A is a perspective view of an aliquot vessel array storage and handling unit useful in the analyzer of FIG. 1;

FIG. 5B is a perspective view of an aliquot vessel unit useful in the analyzer of FIG. 1;

FIG. 6 is a schematic plan view of a container transport system useful in the analyzer of FIG. 1 and in performing the present invention;

FIG. 7 is a perspective view of a container shuttle useful in the analyzer of FIG. 1 and in performing the present invention;

FIG. 8 is a perspective view of a container tray shuttle useful in the analyzer of FIG. 1 and in performing the present invention;

FIG. 9 is a computer interface screen showing access to Instrument Set-up;

FIG. 10 is a computer interface screen showing access to sample racks used within the analyzer of FIG. 1;

FIG. 11A is an illustration of an enhanced matrix indicia of the present invention as applied to a reagent container to be placed within the analyzer of FIG. 1;

FIG. 11B is an illustration of an enhanced matrix indicia of the present invention as applied to a new pump to be placed within the analyzer of FIG. 1;

FIG. 11C is an illustration of an enhanced matrix indicia of the present invention as applied to a calibration vial to be placed within the analyzer of FIG. 1; and,

FIG. 12 is an illustration of an enhanced matrix indicia of the present invention as applied to Calibration and Control values to be used in the analyzer of FIG. 1.

### DETAILED DESCRIPTION OF THE INVENTION

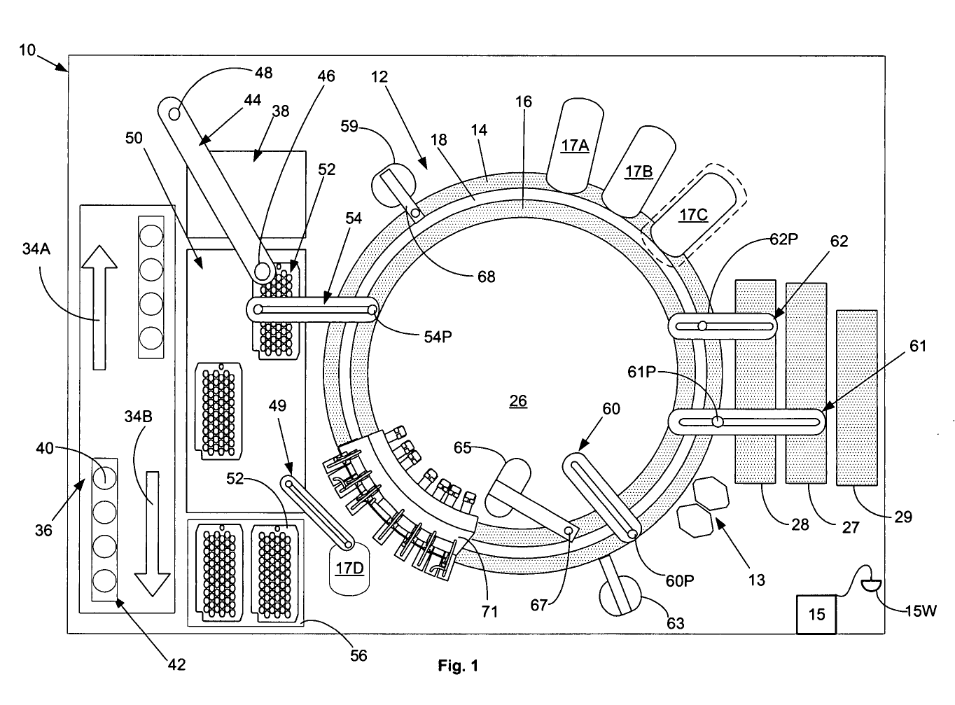

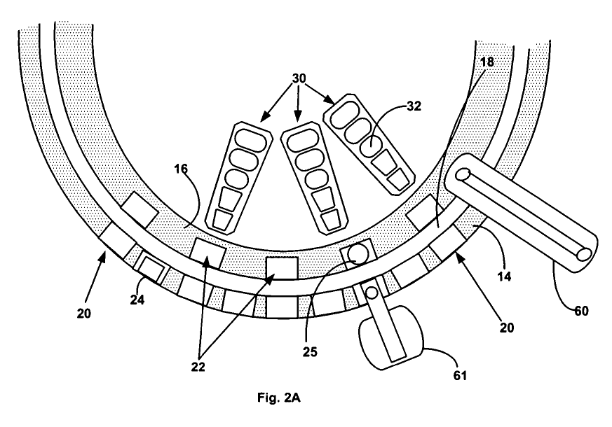

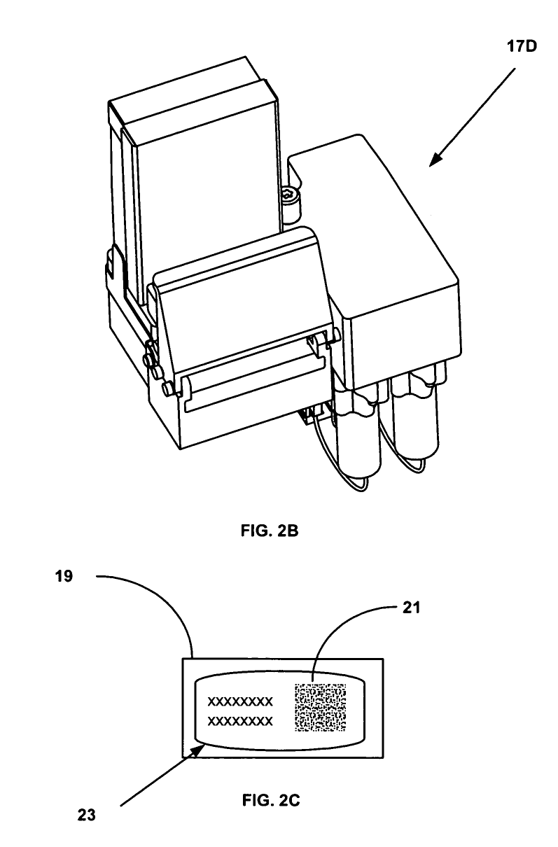

FIG. 1, taken with FIG. 2, shows schematically the elements of an automatic chemical analyzer 10 in which the present invention may be advantageously practiced, analyzer 10 comprising a reaction carousel 12 supporting an outer cuvette carousel 14 having cuvette ports 20 formed therein and an inner cuvette carousel 16 having vessel ports 22 formed therein, the outer cuvette carousel 14 and inner cuvette carousel 16 being separated by a open groove 18. Cuvette ports 20 are adapted to receive a plurality of reaction cuvettes 24 like disclosed in co-pending application Ser. No. 09/949,132 assigned to the assignee of the present invention and containing various reagents and sample liquids for conventional clinical and immunoassay assays while vessel ports 22 are adapted to receive a plurality of reaction vessels 25 that contain specialized reagents for ultra-high sensitivity luminescent immunoassays. Reaction carousel 12 is rotatable using stepwise movements in a constant direction, the stepwise movements being separated by a constant dwell time during which carousel 12 is maintained stationary and computer controlled assay operational devices 13, such as sensors, reagent add stations, mixing stations and the like, operate as needed on an assay mixture contained within cuvettes 24 and reaction vessels 25.

Analyzer 10 is controlled by software executed by computer-based operating control system 15 using computer programs written in a machine language like that on the Dimension® clinical chemistry analyzer sold by Dade Behring Inc, of Deerfield, Ill., and widely used by those skilled in the art of computer-based electromechanical control programming. Operating system 15 also executes application software programs for performing assays conducted by various analyzing units 17A, 17B, 17C and 17D located proximate outer cuvette carousel 14. It is advantageous that analyzing unit 17A be a conventional luminometer or a chemiluminometer configured to allow analyzer 10 to perform luminescent oxygen channeling immunoassays (“LOCI”). LOCI assays provide significant advantage over many conventional immunoassays because they are highly specific and can be performed without time-consuming separation steps. A full description of the LOCI method can be found in U.S. Pat. No. 5,340,716. Analyzing unit 17A preferably is surrounded by an environmental chamber (shown in dotted lines) adapted to shield analyzing unit 17A and the sample being analyzed from environmental light which is detrimental to the assay. Further, reaction vessels 25 and/or the accompanying carousel 16 may be configured to shield light sensitive reagents or reaction mixture from surrounding environmental light.

Remaining analyzing units 17B and 17C may be adapted to detect luminescence, however, they are preferably adapted to perform different, non-luminescence based analyses in order to optimize and diversify the capabilities of the analyzer. For example, analyzing unit 17B may include a photometer or a turbidometer. A suitable photometer is used as part of the Dimension® clinical chemistry analyzer manufactured and sold by Dade Behring Inc. of Deerfield, Ill. Analyzing unit 17C may include yet a different type of detector, such as a nephelometer. Furthermore, analyzing unit 17D preferably is yet another, different type of detector, such as an ion selective electrode (ISE) measuring unit 17D like seen in FIG. 2B using an ISE integrated measuring sensor 19 like seen in FIG. 2C. ISE integrated measuring sensor 19 typically has the form of a disposable cartridge or sensor assembly produced on a planar substrate with plural reference elements and plural sensor elements. Electrical contacts are positioned on the substrate face for each element, and a flow channel is positioned over the substrate reference and sensor elements to direct the sample being analyzed over the sensor elements. Liquid conduits are adapted to supply biological samples to the flow channel and to remove them from the ISE sensor device. ISE integrated measuring device 19 is like that described in U.S. Pat. No. 5,964,994 on which a two-dimensional matrix indicia 21 is printed onto an identifying label 23 affixed to integrated measuring sensor 19. The use of two-dimensional matrix indicia 21 enables the encoding of large amounts of data with user-selected percentages of error correction and is especially advantageous when the identifying label is size restricted smaller than the size of a conventional one dimensional bar code or when more information is needed to be recorded than a conventional one dimensional bar code can encode. Two-dimensional matrix indicia 21 is a nominally square or rectangular symbol made up of square modules on a square or rectangular grid with a square bull's-eye pattern at the center. A typical such symbology known as Aztec Code or Data Matrix symbology, like available from AIM International, Pittsburgh, Pa., has characteristics that include data character encodation, rules for error control encoding, the graphical symbol structure, a reference decoding algorithm and user-selectable application parameters.

Data relating to the operation of analyzer 10 is typically supplied to operating system 15 from a large number of sensors and bar code readers distributed through out the analyzer 10, In addition, a conventional hand-held wand 15W like that available from HHP, based in Skaneateles Falls, N.Y., and having omni-directional reading capability may be used by an operator to manually scan data or bar codes as described hereinafter. Operating system 15 includes an operator interface module typically comprising a keyboard and monitor or a flat-panel touch viewing screen or the like, on which a myriad of information about the operational status of analyzer 10 as described herein may be operator accessed and displayed on screens or which may be automatically displayed like in the instance of a malfunction within analyzer 10. Operating system 15 may be interlinked using known interface software applications with a Laboratory Information System (LIS) and/or a Hospital Information System (HIS) so that information concerning patients, patient assay requests, assay results, analyzer status, and the like, may be immediately accessible as needed by laboratory personnel.

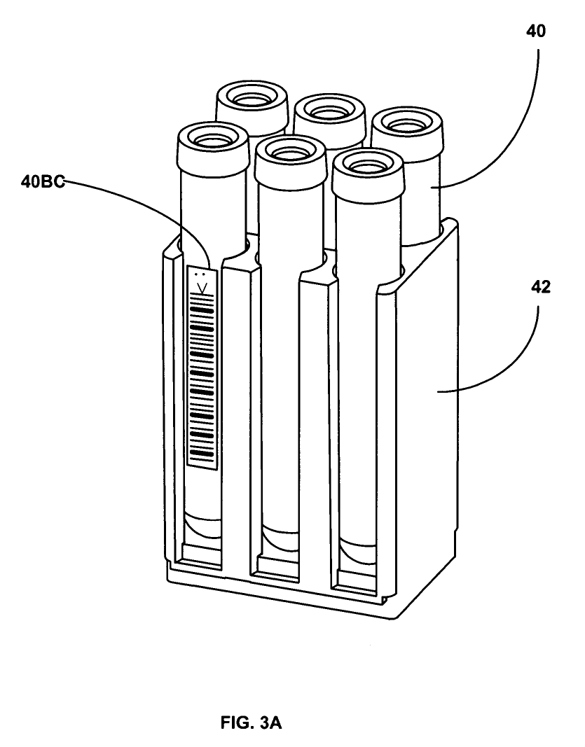

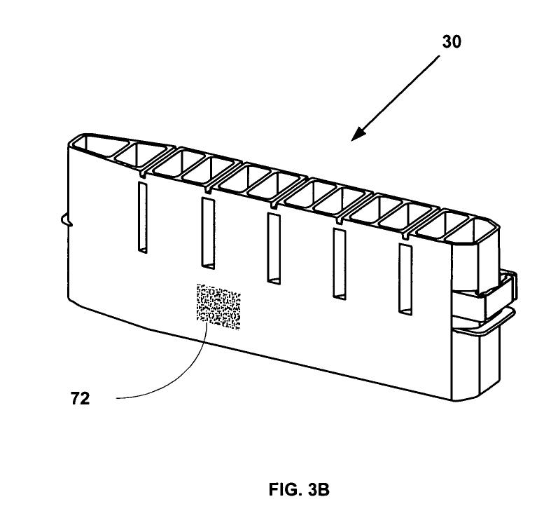

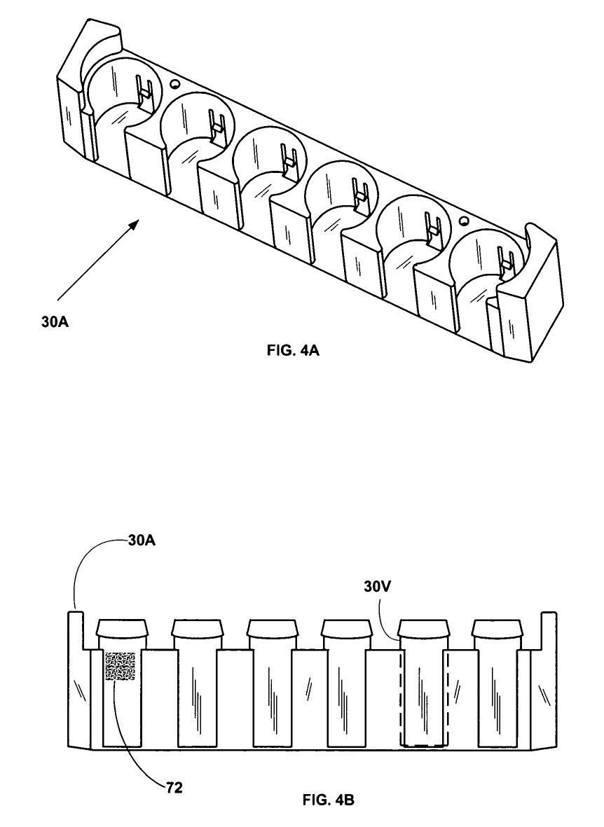

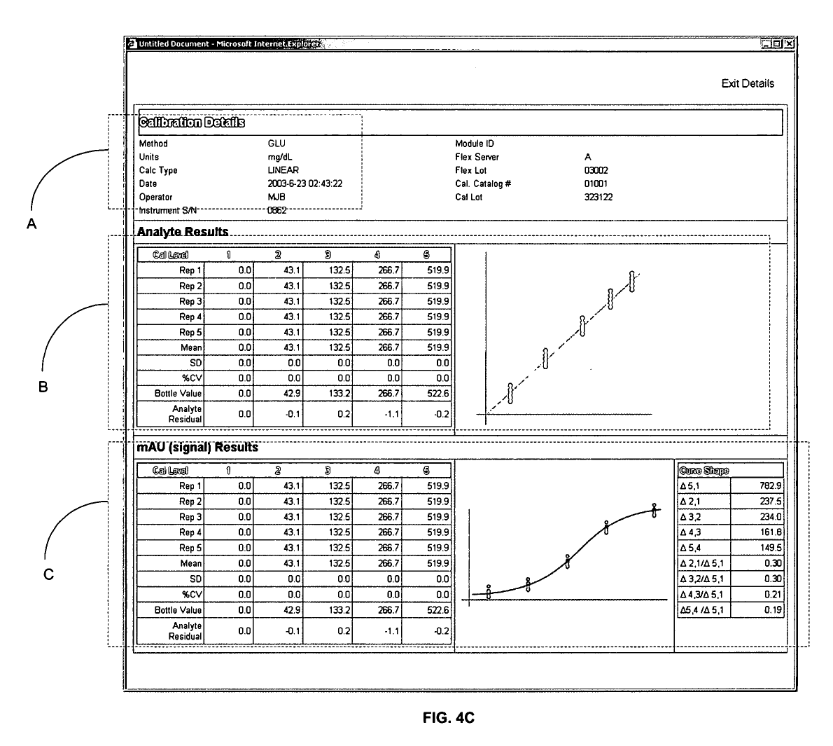

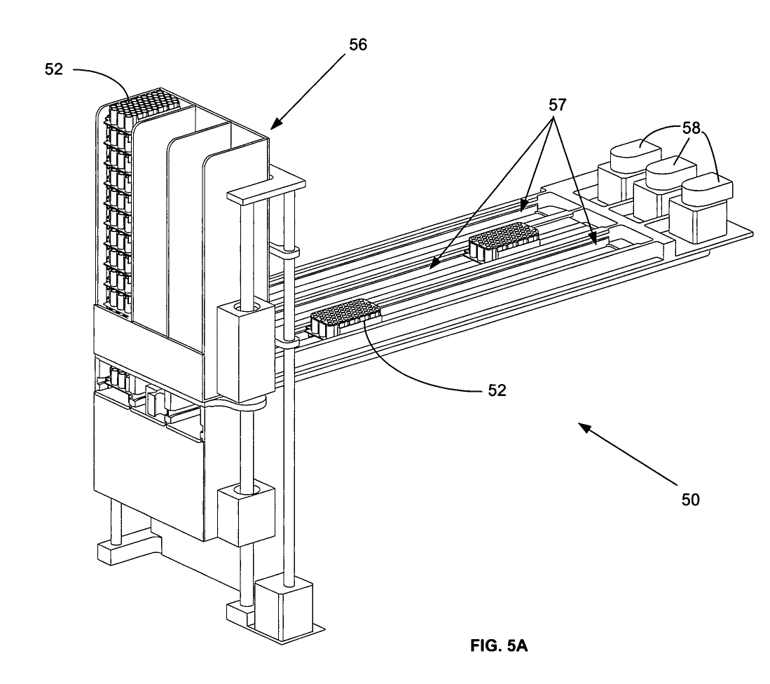

Temperature-controlled reagent storage areas 26, 27 and 28 store a plurality of multi-compartment elongate liquid chemical reagent containers 30 like that illustrated in FIG. 3B, containing reagents necessary to perform a given assay within a number of wells 32, each well containing as much as 3.4 mL of a given reagent. An important feature of the present invention, described hereinafter, is an enhanced reagent indicia 21, having two special characters placed as the leading characters in the reagent indicia 21, to direct information contained thereon to a proper reagent field in operating system 15. FIG. 4A shows a liquid chemical calibration vial container carrier 30A containing calibration solutions of known analyte concentrations in calibration solution vials 30V, the solutions being to conduct well-know calibration and quality control procedures within analyzer 10. As provided by the present invention, calibration vial container 30A also has an enhanced calibration indicia 72, indicia 72 enhanced by having two special characters placed as the leading characters in the vial container indicia 72, to direct information contained thereon to a proper calibration field in operating system 15. Calibration vial containers 30A may also be inventoried upon analyzer 10 within reagent storage areas 26, 27 and 28. As is well known, each calibration vial 30A has an associated set of Quality Control Values recorded a Value Sheet specific to that vial 30A and these values must be entered by an operator into operating system 15 in order for an accurate calibration process to be performed by analyzer 10. This data entering process is time consuming and subject to operator error as may be appreciated from FIG. 4C which illustrates a display screen associated with operating system 15 and having information about assay calibration details, including information about the date a particular method was calibrated by which operator by which type of calibration as seen in area A. The actual results of the calibration process may be found in area B covering analyte test results and in area C covering actual calibration signal results.

A bidirectional incoming and outgoing sample tube transport system 36 having input lane 34A and output lane 34B transports incoming individual sample tubes 40 containing liquid specimens to be tested and mounted in sample tube racks 42, as seen in FIG. 3A, into the sampling arc of a liquid sampling arm 44. Liquid specimens contained in sample tubes 40 are identified by reading a conventional one dimension bar coded indicia 40-BC placed thereon with a conventional bar code reader to determine, among other items, a patient's identity, tests to be performed, if a sample aliquot is to be retained within analyzer 10 and if so, for what period of time, and the like.

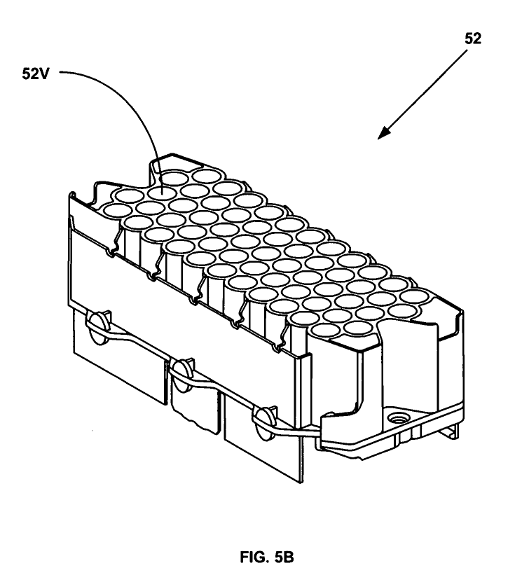

Sampling arm 44 supports a liquid sampling probe 46 mounted to a rotatable shaft 48 so that movement of sampling arm 44 describes an arc intersecting the sample tube transport system 36 and an aliquot vessel array transport system 50, as seen in FIG. 5A. Sampling arm 44 is operable to aspirate liquid sample from sample tubes 40 and to dispense an aliquot sample into one or more of a plurality of vessels 52V in aliquot vessel array 52, as seen in FIG. 5B, depending on the quantity of sample required to perform the requisite assays and to provide for a sample aliquot to be retained by analyzer 10 within environmental chamber 38.

Aliquot vessel array transport system 50 comprises an aliquot vessel array storage and dispense module 56 and a number of linear drive motors 58 adapted to bi-directionally translate aliquot vessel arrays 52 within a number of aliquot vessel array tracks 57 below a sample aspiration and dispense arm 54 located proximate reaction carousel 12. Sample aspiration and dispense arm 54 is controlled by operating system 15 and is adapted to aspirate a controlled amount of sample from individual vessels 52V positioned at a sampling location within a track 57 using a conventional liquid probe 54P and then liquid probe 54P is shuttled to a dispensing location where an appropriate amount of aspirated sample is dispensed into one or more cuvettes 24 in cuvette ports 20 for testing by analyzer 10 for one or more analytes. After sample has been dispensed into reaction cuvettes 24, conventional transfer means move aliquot vessel arrays 52 as required between aliquot vessel array transport system 50, environmental chamber 38 and a disposal area, not shown.

A number of reagent aspiration and dispense arms 60, 61 and 62 each comprising at least one conventional liquid reagent probe, 60P, 61P and 62P, respectively, are independently mounted and translatable between reagent storage areas 26, 27 and 28, respectively. Probes 60P, 61P and 62P are conventional mechanisms for aspirating reagents required to conduct specified assays at a reagenting location from wells 32 in an appropriate reagent container 30, the probes 60P, 61P and 62P subsequently being shuttled to a reagent dispensing location where reagent(s) are dispensed into reaction cuvettes 24. Probes 60P, 61P and 62P are also used for aspirating calibration and control solutions from calibration solution vials 30V as required to conduct calibration and control procedures necessary to ensure proper operation of analyzer 10, the probes 60P, 61P and 62P subsequently being shuttled to a calibration solution dispensing location where solutions(s) are dispensed into reaction cuvettes 24 and analyzed by analyzing means 17A-D.

Reaction cuvette load station 61 and reaction vessel load station 63 are respectively positioned proximate outer cuvette carousel 14 and inner vessel carousel 16 and are adapted to load reaction cuvettes 24 into cuvette ports 20 sideways as described later and reaction vessels 25 into vessel ports 22 using for example a translatable robotic arm 65. In operation, used cuvettes 24 in which an assay has been finally conducted, are washed and dried in a wash station 67 like disclosed in co-pending application Ser. No. __/____ assigned to the assignee of the present invention. Subsequent assays are conducted in cleaned used cuvettes 24 unless dictated otherwise for reasons like disclosed in co-pending application Ser. No. 10/318,804 assigned to the assignee of the present invention. Cuvette unload station 59 is adapted to remove unusable reaction cuvettes 24 from cuvette ports 20 again using a translatable robotic arm 65 like seen on load stations 61 and 63.

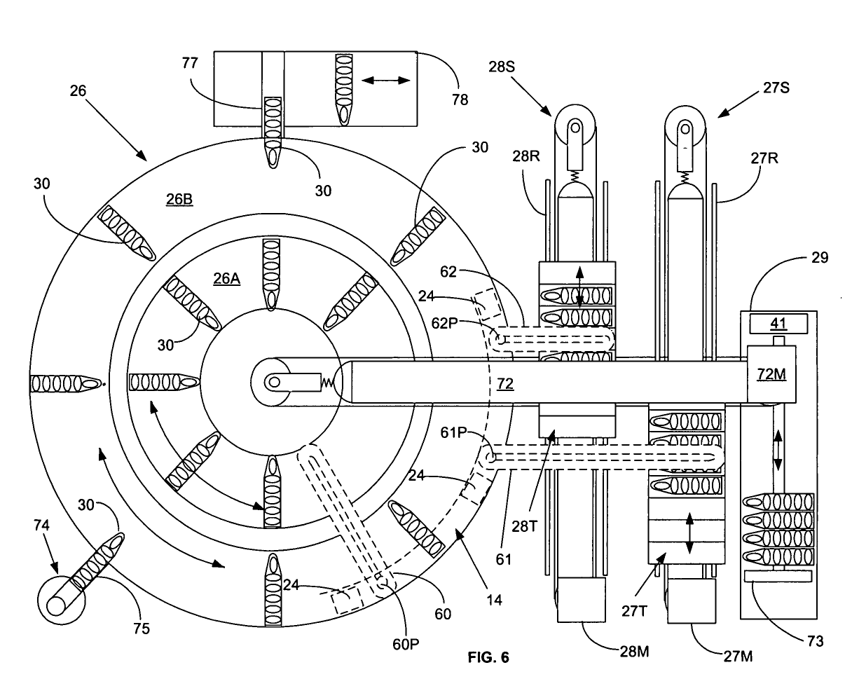

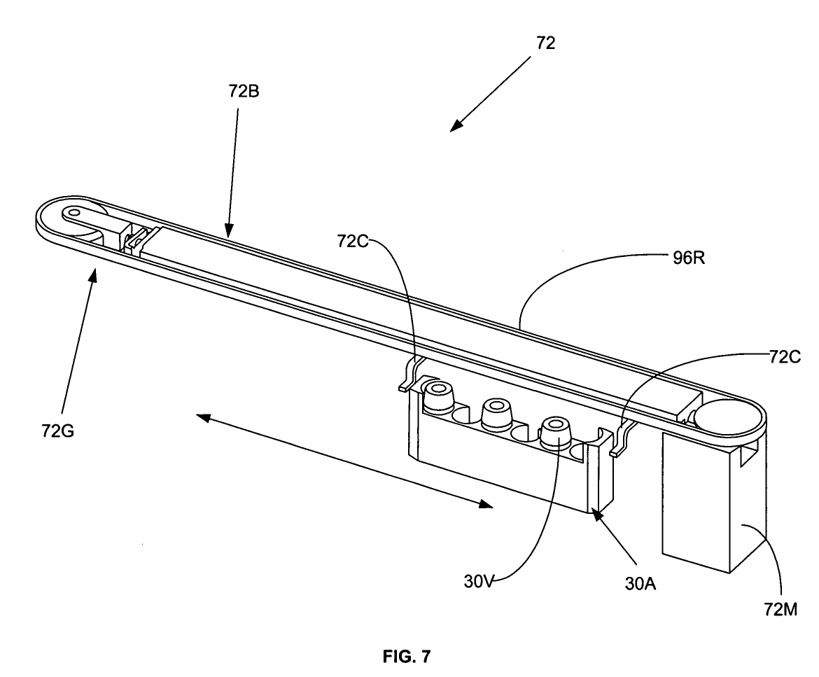

In order to re-supply assay reagents and calibration solutions, analyzer 10 includes a single, bidirectional linear container shuttle 72 illustrated in FIG. 6 and adapted to remove reagent containers 30 and calibration vial containers 30A from a container loading tray 29 having a motorized rake 73 that automatically locates containers 30 and 30A at a loading position beneath container shuttle 72. As each reagent container 30 and calibration vial container 30A is moved into the loading position, an appropriate matrix reader 41 adapted like wand 15W reads the enhanced two-dimensional reagent indicia 21 on reagent containers 30 or the enhanced two-dimensional calibration indicia 72 on calibration vial containers 30V. Shuttle 72 is further adapted to dispose a reagent container 30 or a calibration vial container 30A into slots in at least one slotted reagent container tray 27T or 28T within reagent storage areas 27 or 28, respectively. In a similar fashion, shuttle 72 is even further adapted to remove reagent containers 30 or calibration vial containers 30A from reagent container trays 27T and 28T and to dispose such reagent containers 30 or calibration vial containers 30A into either of two concentric reagent carousels 26A and 26B within reagent storage area 26. Shuttle 72 is also adapted to move reagent containers 30 and calibration vial containers 30A between the two concentric reagent carousels 26A and 26B. As indicated by the double-headed arc-shaped arrows, reagent carousel 26A may be rotated in both directions so as to place any particular one of the reagent containers 30 or calibration vial containers 30A disposed thereon beneath reagent aspiration arm 60. Although reagent carousel 26B may also contain reagent containers 30 and calibration vial containers 30A accessible by reagent aspiration arms 60 and 62, carousel 26B is preferably designated only for storing excess inventory of reagent containers 30 and calibration vial containers 30A. Any one of the reagent containers 30 disposed in reagent container trays 27T and 28T may be located at a loading position beneath container shuttle 72 or at a reagent aspiration location beneath aspiration and dispensing arms 61 and 62, respectively, by reagent container shuttles 27S and 28S within reagent storage areas 27 and 28, respectively. Reagent aspiration arms 60 and 62 are shown in dashed lines to indicate that they are positioned above the surfaces of reagent containers 30 inventoried in carousel 26B, and reagent container trays 27T and 28T, respectively. Reaction cuvettes 24 supported in outer cuvette carousel 14 are also both shown in dashed lines to indicate that they are positioned above the surfaces of reagent containers 30. A container shuttle system like seen in FIG. 6 is described in co-pending U.S. patent Ser. No. __/____ assigned to the assignee of the present invention.

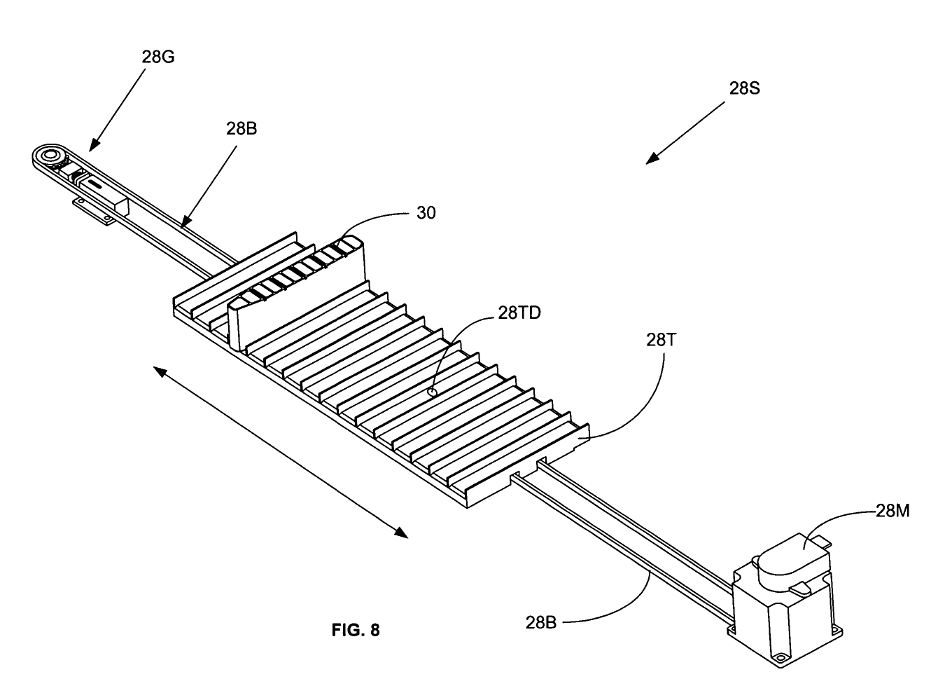

Container shuttle seen in FIG. 7 is adapted to automatically compensate for unknown changes in length of a drive belt 72B driven by motor 72M by an automated tensioner 72T adapted to maintain a constant tension on the drive belt 72B regardless of rapid changes in its driving direction so that reagent containers 30 and calibration vial containers 30A attached thereto by clamps 72C may be accurately positioned along the direction of drive belt 72B, as indicated by the double-ended arrow, and disposed at their intended location beneath reagent container shuttle 72 or within storage areas 26, 27 or 28 as drive belt 72B wears. Reagent container shuttles 27S and 28S are similar in design to one another, and as seen in FIG. 8, include a reagent container tray 28T secured to one leg of a drive belt 28B so that tray 28T is free to be driven to and from along the direction of drive belt 28B, as indicated by the double-ended arrow. Consequently, reagent containers 30 within slots in tray 28T may be automatically positioned at a pick-up location beneath container shuttle 72.

From the preceding description of analyzer 10, it is clear to one skilled in the art that the capabilities of analyzer 10 under the control of operating system 15 include the ability to automatically to move reagent containers 30 and calibration vial containers 30A between container loading tray 29, reagent container trays 27T and 28T, and reagent carousels 26A and 26B. By means of shuttles 27S and 28S, analyzer 10 is further capable of moving reagent containers 30 and calibration vial containers in reagent container trays 27T and 28T to appropriate aspiration locations by probes 61P and 62P, respectively, (or to a loading location beneath shuttle 72 so that in combination with the capability of reagent carousels 26A and 26B to place any reagent container 30 or calibration vial container 30A beneath reagent aspiration arms 60P, 61P and 62P. Analyzer 10 thus includes an automated random access reagent and calibration solution re-supply system with the flexibility to position a large number of different reagents and calibration solutions at different aspiration locations.

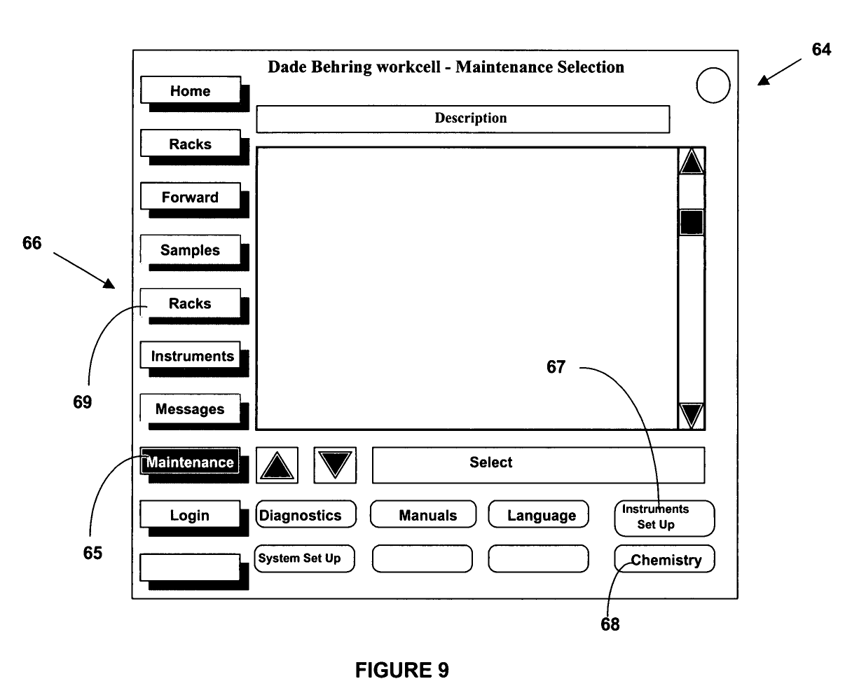

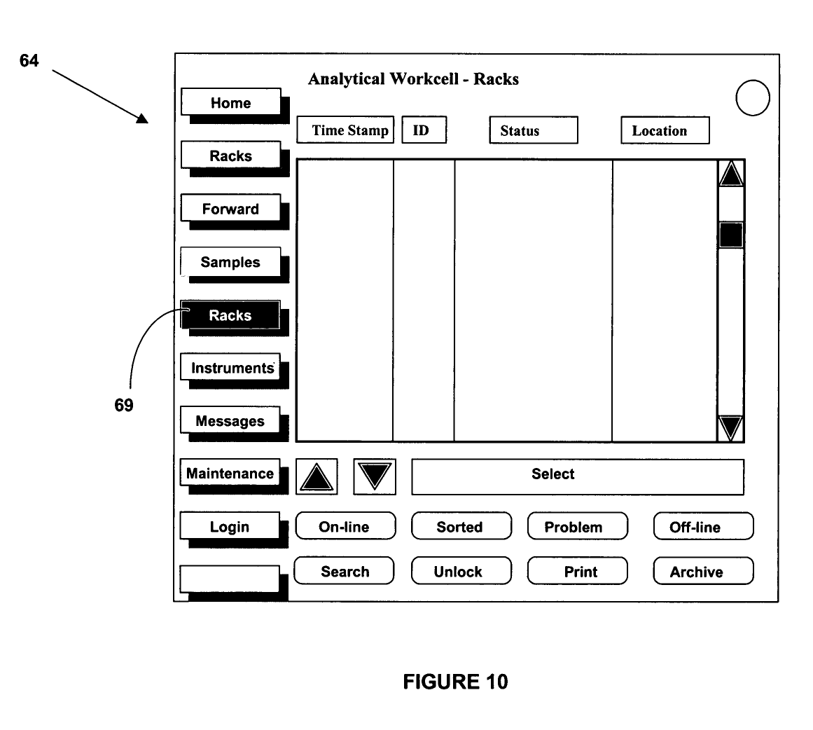

As is well known, analyzer 10 comprises a large number of electro-mechanical devices, pumps, motors, sensors, heaters, and the like, and such components may need to be replaced on a scheduled or unscheduled time and/or wear basis. In order to facilitate replacing such items, the components are typically identified by serial number tracking and the serial numbers of all such components are stored in memory in operating system 15. When a component object is replaced within analyzer 10, the serial number of the newly installed component has to be entered into memory, either manually or by scanning a bar code or other symbol with wand 15W. At such time, it is necessary for the installer to have the proper data screen displayed on operating system 15, and this typically requires the installer to move through a multi-step screen selection process. While the screen selection may be simplified by using a so-called “Computer operator interface module having a flat menu” like that disclosed in U.S. Pat. No. 10/___,___. FIG. 9 shows a Maintenance Selection screen 64 adapted within operating system 15 to display a list of possible maintenance selections associated with analyzer 10 that may be readily accessed by selecting the Maintenance button 65 from among a group of function buttons 66. Pressing a button identified as Instruments Setup 67 causes a list of Instrument Setup screen selections to be displayed into which installed component part numbers and serial numbers and the like may be entered. Pressing a button identified as Chemistry 68 causes a list of Chemistry Setup screen selections to be displayed into which information concerning reagent containers 30 and calibration vial containers 30A, integrated measuring sensor 19, calibration and Quality Control values, and the like, may be entered by an operator. FIG. 10 illustrates a Racks screen 69 adapted within operating system 15 to display additional information on a specific sample tube rack 42 that may be readily accessed by selecting the Racks button 70 from among the group of function buttons 66. The Racks screen displays a list of racks based on the group selected by the screen specific function buttons 66.

An important factor in maintaining an optimum assay throughput within analyzer 10 is the ability to timely re-supply reagent containers 30 into reagent storage areas 26, 27 and 28 before the reagents contained therein become exhausted. Similarly important is the ability to timely re-supply calibration and Quality Control solutions in vial containers 30A before the solutions contained therein become exhausted so that calibration and control procedures may be conducted as required, whether this be based on the basis of time between calibrations or number of assays performed since an immediately previous calibration or number of assay results outside normal ranges, or changes in the performance of the analyzer. This challenge may be met by timely equipping analyzer 10 with additional requisite calibration and Quality Control solutions used in calibration and control procedures and called standard chemical solutions herein for convenience, before they become exhausted, thereby maintaining assay throughput of analyzer 10 uninterrupted.

In order to maintain continuity of assay throughput, operating system 15 is programmed to track reagent and assay chemical solution consumption along with time, and date of consumption of all reagents consumed out of each reagent container 30 and assay chemical solutions consumed out of each vial container 30A on a per reagent container, per calibration vial container, per Quality Control container, per assay, and per calibration basis, for specifically defined time periods. Using this consumption data, time, and current reagent container 30 and calibration vial container 30A inventory data of already on-board standard chemical solutions within storage areas 26, 27 and 28, operating system 15 is programmed to make an inventory demand analysis for specifically defined time periods so as to determine future assay inventory demands for the specifically defined time periods and display or issue to an operator a “replenish listing” of all of the reagent containers 30 and calibration/Quality Control vial containers 30A that will be needed in the near future in a timely manner prior to the actual need of reagent container 30 and calibration/Quality Control vial containers 30A. An operator will use the “replenish listing” in order to timely re-supply reagent containers 30 and vial containers 30A into analyzer 10 by placing the requisite reagent containers 30 and vial containers 30A into container loading tray where matrix reader 41 reads the enhanced two-dimensional reagent indicia 21 on reagent containers 30 or the enhanced two-dimensional calibration indicia 72 on calibration vial containers 30. As explained herein, an important feature of the present invention is the addition of two special characters forming a leading symbol at the beginning of the identifying indicia on reagent containers 30 and calibration vial containers 30 in order that operating system 15 is enabled to automatically direct the information obtained from the indicia to the appropriate location within operating memory without requiring any operator intervention.

From the above description of analyzer 10, operating system 15 is programmed to record and/or control, among other more notable items:
patient's identity, the tests to be performed, if a sample aliquot is to be retained within analyzer 10;
sample tube transport system 36 and racks 42 therein;
reagent and assay chemical solution consumption along with time, and date
consumption of all reagents consumed out of each reagent container 30;
consumption of all assay chemical solutions consumed out of each vial container 30A;
identify of re-supplied assay reagent containers 30;
calibration and quality control procedures;
identity of re-supplied calibration vial containers 30A;
time-in-use and/or performance of replaceable components;
identity and serial numbers of replacement components;
time in use and/or performance of ISE integrated measuring sensor 19;
identity of replacement ISE integrated measuring sensors 19;

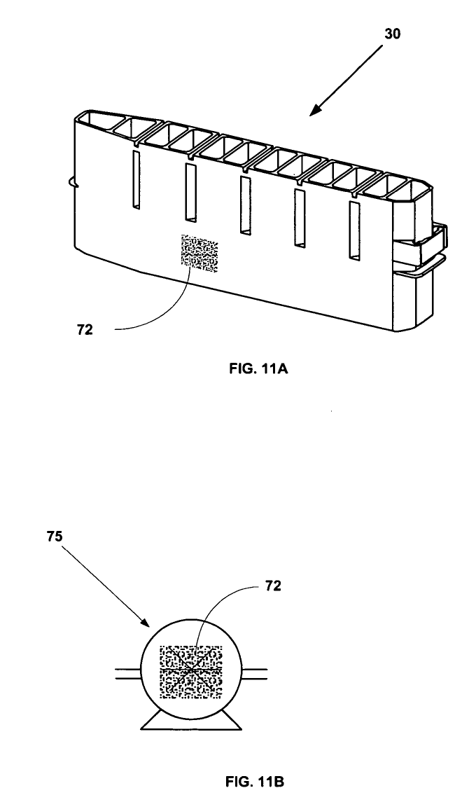

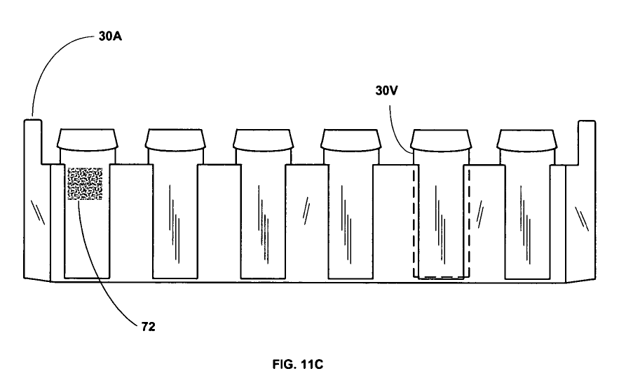

Clearly, from the above descriptions of the multiple operations conducted within analyzer 10 as controlled by operating system 15, it is apparent that a problem to be resolved is how an analyzer technician can easily enter into operating system 15 information pertinent to a given situation, in a most, so-called “user-friendly” manner. A key feature of the present invention is the addition of two special characters selected from the group of well-known Hex Codes like those seen in Table 1 to form a leading symbol at the beginning of an otherwise conventional one dimension bar code like 40-BC seen in FIG. 3A in order to enable operating system 15 to either automatically direct the information obtained from the bar code to the appropriate location within operating memory or to automatically cause operating system 15 to display the appropriate screen field so that an operator may manually enter the associated date without requiring the operator to perform the input operations normally associated with operating screens like those seen in FIGS. 9 and 10. Similarly, the present invention provides for the addition of two special characters selected from the group of well-known Hex Codes like those seen in Table 1 to form a leading symbol at the beginning of an otherwise conventional two-dimension matrix indicia like 72 seen in FIGS. 11A and 11B as these objects are placed into analyzer 10 in order to enable operating system 15 to automatically direct the information obtained from the matrix indicia to the appropriate location within operating memory. Preferred special characters shown in Table 1 form a leading symbol linked to the product shown. In use, and in accord with the present invention, operating system 15 is programmed to automatically display the appropriate Linked Product screen or to automatically enter the identifying data for the Linked Product without requiring an operator to perform the usual operating system display manipulation steps like those described for FIGS. 9 and 10.

As another example, if an operator is replacing a malfunctioned aspiration pump by putting a new, unused pump 75, FIG. 11B, into analyzer 10, wand 15W is used to read the enhanced two-dimensional matrix indicia 72 like seen in FIG. 11B and having the leading symbol “:}”. Operating system 15 recognizes “:}” as associated with Linked Product Component Part Number and automatically causes the appropriate Instrument Maintenance screen to be displayed by operating system 15 without requiring the operator to navigate through several display screens. Subsequently, wand 15W is used to read the enhanced two-dimensional matrix indicia having the leading symbol “:{”. Operating system 15 recognizes “:{” as associated with Linked Product Component Serial Number and automatically causes the appropriate Instrument Maintenance screen to be displayed by operating system 15 without requiring the operator to navigate through several display screens.

As an additional example, if an operator is replacing an expiring Integrated Measuring Sensor 19 by putting a new, unused Integrated Measuring Sensor 19, FIG. 2C into analyzer 10, wand 15W is used to read two-dimensional matrix indicia 21 having the leading symbol “;!” Operating system 15 recognizes “:!” as associated with Linked Product Integrated Measuring Sensor 19 and automatically causes the appropriate Instrument Set Up screen to be displayed by operating system 15 without requiring the operator to navigate through several display screens.

TABLE 1

| Leading | | |
|---|---|---|
| Symbol | Hex Code | Linked Product |
| : % | 3A 25 | Calibrator Vial |
| : ) | 3A 29 | Calibrator Values from a Value Sheet |
| : & | 3A 26 | Open Source Quality Control Vial |
| : * | 3A 2A | Closed Source Quality Control Vial |
| : ( | 3A 28 | Quality Control Values from a Value Sheet |
| : } | 3A 7D | Component Part Numbers |
| : { | 3A 7B | Component Serial Numbers |
| : [ | 3A 5B | Reagent Container 30 |
| : ! | 3A 21 | Integrated Measuring Sensor 19 |
| : ] | 3A 5D | Assay Chemical Parameters |
| :> | 3A 3E | Sample Tube Rack 42 |
| : : | 3A 3A | Reserved for Expansion |

FIG. 11A is exemplary of the enhanced two-dimensional matrix indicia 72 of the present invention affixed to a Reagent Container 30; FIG. 11B is exemplary of a different enhanced two-dimensional matrix indicia 72 of the present invention affixed to a pump 73; FIG. 11C is exemplary of a different enhanced two-dimensional matrix indicia 72 of the present invention affixed to a calibrator vial 30A. It is within the teaching of the present invention that both one-dimension bar codes and two-dimensional matrix indicia may be enhanced by placing two special characters as a leading symbol at the beginning of an otherwise conventional one-dimension bar code or two-dimension matrix indicia on objects being placed into analyzer 10 in order to enable the information encoded in the bar or matrix indicia to be automatically directed to the appropriate location within operating system 15 without requiring the intervention of an operator. The advantages of this invention may be appreciated by recognizing that information encoded on two-dimensional matrix indicia 72 includes:
1. Special Characters “:[”;
2. Method Identification;
3. Year of Manufacture;
4. Day of Manufacture;
5. Sequence of Manufacture (based on order produced);
6. Expiration Interval;
7. Container Configuration (number of wells);
8. Reagent Specific Information;
9. Volume (sometimes half filled in the event of low usage);
10. Method Specific Coefficients (
11. Correction Factor Y (example +1.03);
12. Correction Factor X (example −0.02);
13. HIBBC Healthcare Number; (example H505); and,
14. Catalog Number,
   and this information is automatically directed to the appropriate memory location within operating system 15 for automatic display on the appropriate screen for an operator without requiring any operator intervention. As a matter of illustration, the following is a full data stream that might be encoded on a reagent container 30; the presence of the special characters “:[”; automatically directing the data stream appropriately into operating system 15.

;]0106013650001280720A1A1A1AB+4.230+01+2.230−03+3.230+01+0.230=01=0.500−01+9.99+9.99H505DFC245

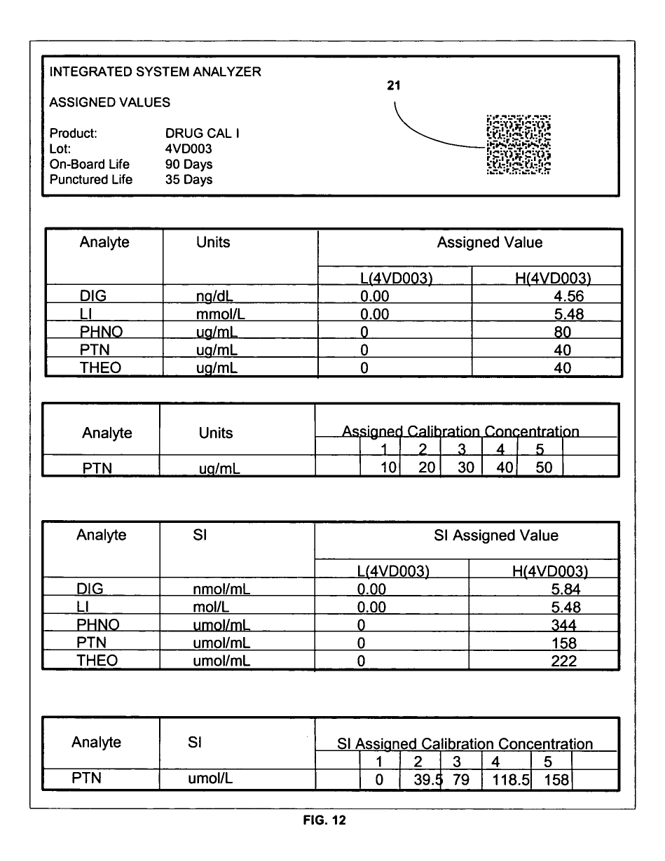

FIG. 12 illustrates a typical Insert Sheet that contains Calibrator Values for a multi-analyte calibrator having high and low Control values as well as a series of Calibration Values. Whenever a new lot of such quality control solutions contained in vials 30V are placed into container loading tray 29, matrix reader 41 reads the enhanced two-dimensional matrix indicia 72 on calibration vial containers 30V and identifies the object being placed on analyzer 10 as a vial container 30V so they may be tracked within analyzer 10 for retrieval at a future time when needed to maintain calibrated throughput of analyzer 10. As part of this process, the Control and Calibration Values associated with each of such quality control solutions must also be provided to the operating program of operating system 15. Historically this has been done by manually entering the Control and Calibration Values into memory using an alpha-numeric keypad after selecting the Chemistry button 68 on screen 64 (FIG. 9). Using the two-dimensional matrix indicia 21 as provided by the present invention, however, and containing the special characters “:)” linked to Calibrator Values from a Value Sheet as seen in Table 1, when the two-dimensional matrix indicia 21 is scanned by the operator using wand 15W, all and Calibration Values associated with each of the quality control solutions is automatically entered into memory in operating system 15, eliminating both the time requirement and opportunities for input error readings. The advantages of this invention may be appreciated by recognizing that information encoded on two-dimensional matrix indicia 21 includes:
1. Special Characters“:)”;
2. Manufacturing Lot Number;
3. Year of Manufacture;
4. Month of Manufacture;
5. Source of Manufacture (Supplier of the Object);
6. Catalog Number;
7. Volume of Fluid in Vial;
8. Levels of Calibration;
9. Formulation Identity;
10. Expiration Date;
11. Number of times the Vial May be Pierced;
12. Sample Fluid Type (Serum, Plasma, Urine, Amniotic and the like);and,
13. Tracking Number,
   and this information is automatically directed to the appropriate memory location within operating system 15 for automatic display on the appropriate screen for an operator without requiring any operator intervention.

It will be appreciated by those skilled in that art that a number of variations may be made in the above described method and still achieve the essence of the present invention. Different specifically defined time periods may be defined, or a different number of previous but the same specifically defined time periods may be used to calculate an average assay demand for that specifically defined time period, and other variations may be employed and still be within the method disclosed For these reasons, the present invention is not limited to those embodiments precisely shown and described in the specification but only by the following claims.

1. A method to automatically enter data into a clinical analyzer's operating control system, the data associated with an object to be placed into the clinical analyzer, by providing special symbols as an additional identifier in indicia affixed to the object, reading the indicia, the operating control system adapted to use the special symbols to automatically determine where the data are to be stored therein.

2. The method of claim 1 wherein the special symbols identify the type of object to be placed into the analyzer.

3. The method of claim 1 wherein the indicia affixed to the object are one-dimensional barcode indicia.

4. The method of claim 1 wherein the indicia affixed to the object are two-dimensional matrix indicia.

5. The method of claim 1 wherein the special symbols comprise two characters selected from among Hex Code symbols.

6. The method of claim 5 wherein the special symbols comprise two characters selected from the group consisting of %, 0, &, *, (,}, {, [,], !, :, and >.

7. The method of claim 1 wherein the type of object to be placed into the analyzer comprises liquid chemical containers.

8. The method of claim 1 wherein the type of object to be placed into the analyzer comprises electromechanical components.

9. The method of claim 1 wherein the type of object to be placed into the analyzer comprises integrated sensors.
